(19) United States
(12) Patent Application Publication
(10) Pub. No.: US 2011/0051946 A1
(43) Pub. Date: Mar. 3, 2011

(54) Air conditioner with integrated sound system

(76) Inventor: Paul William Gardiner, Happy Valley (HK)

(21) Appl. No.: 12/803,894

(22) Filed: Jul. 9, 2010

Related U.S. Application Data
(60) Provisional application No. 61/275,801, filed on Sep. 3, 2009.

(51) Int. Cl. G10K 11/16; F25D 23/00

(52) U.S. Cl. 381/71.3; 62/296

(57) ABSTRACT

The subject system combines a sound generating controller device with a domestic air conditioning unit. The sound controller synchronises the speed and direction of the airblower and directional airflow vanes, thus being able to simulate a variety of natural environments. The integration of a sound generation device, and the further synchronisation of these sounds with the operation of the airflow speed and directional controls on the air conditioner, are distinguishing features of this system proposal. An active noise canceller is optional, to further eliminate unwanted external noises.

### CONTENTS

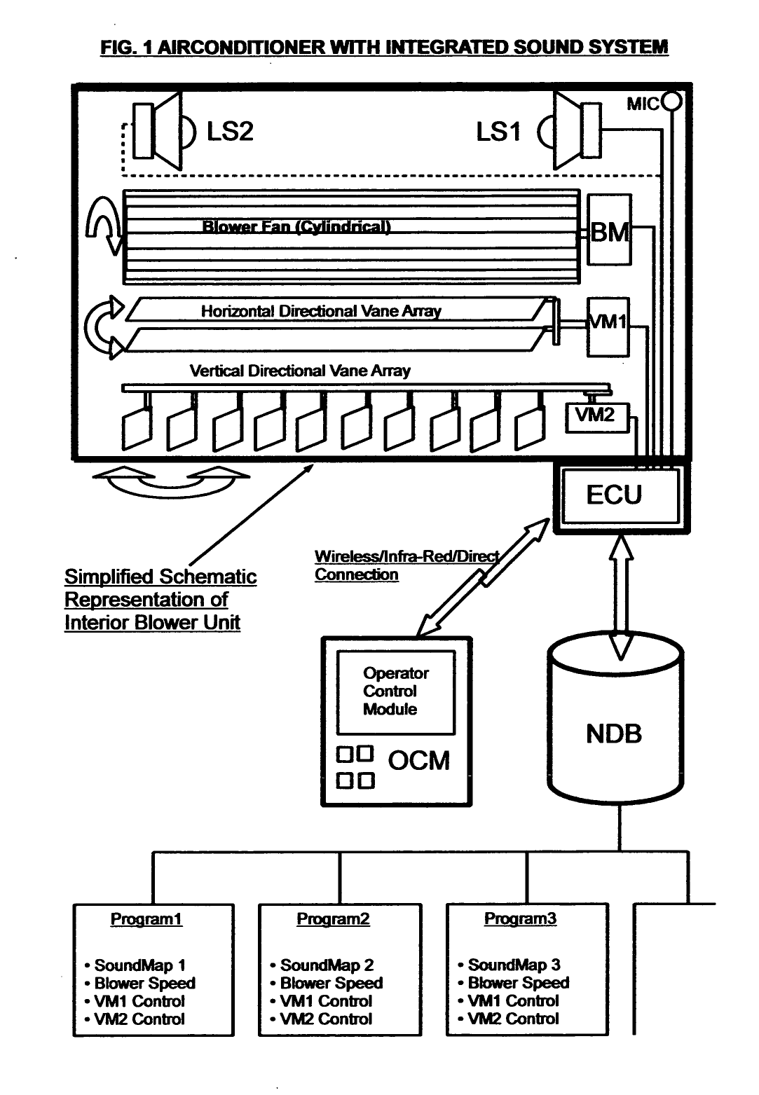

1. Executive Summary
2. Key to FIG. 1
3. Description of System and Operation
4. Table of Operation Modes
5. Table of Timer Operation Examples
6. Explanatory Notes

### 1. EXECUTIVE SUMMARY

This system combines a sound generating controller device with a domestic airconditioning unit. The sound controller also controls the speed and direction of the airblower and directional airflow vanes, thus being able to simulate a variety of natural environments. The integration of natural sounds, and the further synchronisation of these sounds with the operation of the air controls on the airconditioner, are distinguishing features of this system proposal.

An active noise canceller is optional, to further eliminate unwanted external noises.

The benefits of this system are:
therapeutic, as natural sounds have been shown to assist sleep and rest
reduction in intrusive fan noises, as these are concealed by the sound generating device
elimination of other unwanted external noises if the optional active noise canceller is fitted.

This application is in respect of the overall system concept and layout

This system design is different from other patents which for example, link temperature and humidity control to a broadcast television program for enhancing the sense of realism of the viewer. This system does not link operation to audio/visual broadcast programming and does not rely on broadcasting of any signals. Furthermore, the synchronisation of the inbuilt soundtracks is for the purpose of coordinating control of airflow direction and speed of airflow with the natural sounds.

### 2. Explanation of FIG. 1

FIG. 1 is a simplified representation of the internal blower unit of a typical air conditioning system, showing the connections between the various components of the integrated sound system. (The external compressor and heat exchangers are not depicted here as they are not relevant to the specific application.) A typical blower unit comprises a motorised Blower Fan, a motorised Horizontal Directional Vane Array (to direct air flow in a vertical, or up-and-down direction) and a motorised Vertical Directional Vane Array (to direct air flow in a horizontal, or side-to-side direction). Filters, thermostats, and other components not relevant to this application are not depicted in this representation.

### KEY

The descriptions and functions of the components shown in FIG. 1 are:

ECU Electronic Control Unit: the ECU receives instructions from the operator control module (“OCM”), including choice of natural sound as well as other normal airconditioner functions or settings. The ECU includes a sound amplifier where this is not part of the loudspeakers. Based on the instructions received by the ECU, it will access the electronic database (“NDB”) to retrieve the relevant program information comprising control data for the operation of the Blower Motor and motorised Vane Arrays in synchronisation with the generation of the selected sound track.

BM Blower Motor: the speed of the blower motor, and hence the strength of the airflow, is controlled by the ECU according to the selected program.

VM1 VM1 is the motor that controls the Horizontal Vane Array up-and-down motion and direction of the airstream in a vertical (up or downwards) direction. VM1 is controlled by the ECU according to the selected program.

VM2 VM2 is the motor that controls the Vertical Vane Array side-to-side motion and direction of the airstream in a sideways (left or right) direction. VM2 is controlled by the ECU according to the selected program.

LS1 Loudspeaker 1 produces the soundtrack (includes a sound amplifier where not part of the ECU)

LS2 Loudspeaker 2 (optional) produces the soundtrack for a stereo effect together with LS1. Additional loudspeakers can be added to give multi-dimensional sound effects, including remote loudspeakers not actually built-in to or attached to the airconditioner blower unit itself. Amplifiers are included with the speakers or as part of the ECU.

OCM Operator Control Module, similar to a typical handheld or wall-mounted remote controller including all the programming features required to set the desired programs as well as normal air conditioner settings such as temperature, etc.

MIC Noise cancel system microphone (optional). Where an active noise cancellation system is installed, the microphone is required to detect sounds and pass to the control unit for the generation of the noise cancelling signal.

NDB NatureSound Database comprising an electronic database of NatureSound programs, each program comprising a) a soundtrack and b) an instruction sequence for controlling the operation of the airconditioner blower speed, horizontal and vertical airflow direction in synchronisation with the selected soundtrack (Note: in “basic” models with sound only, the instruction sequence is either unused or not installed.)

### 3. Description of System and Operation

The system comprises a regular standard modular airconditioner unit¹ with additional electronic features comprising an ECU (Electronic Control Unit), an electronic database of “natural sound” programs, and an operator control input unit, either remote control or wired (directly connected) control. 1 Note: These units typically comprise an external compressor unit mounted outside the building, and an internal blower unit mounted inside the room on a wall or suspended from the ceiling. The blower and compressor are connected by refrigerant pipes, power cables and control wires, etc. All-in-one units we typically window mounted or wall mounted and comprise blower and compressor in one “box”.

The system design can also be applied to “central” airconditioner units at the room outlets, where individual room controls are available.

The operator selects desired natural sound programs from the controller and “sends” the instruction to the airconditioner. The ECU detects the desired instruction, selects the program from the built-in database (“NDB”), and operates the airconditioner blower will

Each Nature Sound program on the NDB Database comprises (1) a soundtrack (or “sound map”), which is played through the loudspeaker(s) LS1, LS2, etc, and (2) a blower unit control instruction map. The control instruction map comprises commands for the Blower Motor (“BM”) and Vane Activator Motors (VM1, VM2, VM3, etc) where fitted. Each program synchronises the motor speed and horizontal and vertical vane activation with the program's soundtrack to simulate a natural environment Examples of these environments are described in the Table of Operation Modes. The controller will also allow the operator to override specific settings for BM, VM1, VM2, etc manually, while retaining the soundtrack.

While the operation of the blower speed and vane activation is a feature of this system, this design also anticipates a “simplified” version where integration of the sound unit is accomplished without synchronisation with the air speed or direction. The air-conditioner can also be controlled with the sound system de-activated.

The operator may also select “sleep” and other “timer” options from the control unit to control the mode when switching on, off or at any period in between (Section 5).

### 4. Table of Operation Modes (examples for illustration)

| Natural Sound | Description of | Blower Motor | | |
|---|---|---|---|---|
| Program | Soundtrack | Speed | VM1 Activation | VM2 Activation |
| SeaSurf | Sounds of ocean | Medium to High, | Up and down, | Fixed |
| | waves on a sandy | synchronised to | synchronised to | |
| | beach | sound of waves | wave sounds | |
| LakeSide | Sounds of ripples | Low to Medium, | Up and down, | Fixed |
| | lapping on a lakeshore | synchronised to | synchronised to | |
| | | sound of waves | wave sounds | |
| MountainForest | Sounds of wind in | Low to Medium | Fixed | Side to side, |
| | trees | speed | | synchronised to |
| | | | | sound of wind |
| Tropic- | Sounds of a gale | Medium to high | Fixed | Side to side, |
| Hurricane | | speed | | synchronised to |
| | | | | sound of wind |
| RainShower | Sound of gentle rain | Low speed, | Gentle up and | Gentle side to side |
| | falling | mainly constant | down movement | movement |
| River | Sound of rushing | Medium speed | Up and down, | Side to side, |
| | water | | synchronised to | synchronised to |
| | | | water sounds | water sounds |
| Mountain- | Sound of a bubbling | Low speed | Gentle up and | Gentle side to side |
| Stream | stream or brook | | down movement | movement |
| WaterFall | Sound of water | Medium to High | Rapid up and down | Rapid side to side |
| | cascading down | speed, gentle | movement | movement |
| | | varation | | |
| BirdSong | Sound of songbirds | Low speed | Gentle up and | Gentle side to side |
| | and other birds | | down movement | movement |
| OceanSunrise | Combined sound of | Low to Medium, | Up and down, | Fixed |
| | waves and quiet | synchronised to | synchronised to | |
| | birdsong | sound of waves | wave sounds | |
| White Noise | Random noise | Constant, speed | Manually set by | Manually set by |
| | generator | manually set by | operator | operator |
| | | operator | | |
| Noise | Cancels external | NA | NA | NA |
| Cancellation | noises via actve | | | |
| (Optional)² | feedback | | | |

²The optional noise cancellation system component may be subject to licensing from relevant patent owners as appropriate.

The above illustrations are not exhaustive and many other sound/operation combinations can be devised for this system. Further, as noted above, in “basic” form, the system can incorporate the soundtracks with limited control of the blower or direction vanes.

### 5. Table of Timer Control Examples

| | Purpose | | | | |
|---|---|---|---|---|---|
| | Program | | | | |
| Time of Day | Setting | Nature Sound | Sleep Mode | Time On | Time Off |
| Evening | Normal | Mountain | Off | NA | NA |
| | | Forest | | | |
| Going to Sleep | Sleep (60 | White Noise | On | Immediate | +60 minutes |
| | minutes) | | | | later |
| Sleep | Revert to | Mountain | NA | NA | NA |
| | previous setting | Forest | | | |
| Waking Up | Timer 7.00 am | OceanSunrise | NA | 7.00am | NA |

### 6. Explanatory Notes

Programs/Program Updates

The proposed system includes factory installed operation programs (soundtrack, fan speed and vane activation controls) as part of the control system. The system can also include the facility for the operator/domestic user to insert or connect memory cards with additional soundtracks and/or to create their own sound tracks and operation programs. This would also allow the manufacturer to issue program updates and new programs from time-to-time.

Operator Control

Operator control and programming of the system can be as complex and flexible as allowed by the operator's control unit. The number of natural sound “Nature Sound” programs is restricted only by considerations relating to inter alia memory capacity of the database chip and the creation of the soundtrack programs.

I claim:

1. An airconditioning system comprising:
(a) An interior blower unit,
(b) Loudspeakers or sound producing devices, and amplifiers,
(c) A control unit that controls the operation of the blower fan, horizontal and vertical airflow directional vanes (where fitted),
(d) A database of soundtracks and related blower control instruction maps.

2. An airconditioning system according to claim 1 which generates sounds from the database of soundtracks.

3. An airconditioning system according to claim 1 which synchronises the sound generation with the speed of the blower fan and the direction of the airflow.

4. An airconditioning system according to claim 1 which allows the operator to select from a range of soundtracks and blower unit command instructions.

5. An airconditioning system according to claim 1 which allows the operator to input his/her own instructions to the blower unit.

6. An airconditioning system according to claim 1 which allows the operator to load his/her own soundtracks to the database.

7. An airconditioning system according to claim 1 which includes a built-in active noise canceller to reduce or eliminate unwanted background noises.
